(19) United States
(12) Patent Application Publication
(10) Pub. No.: US 2023/0352040 A1
(43) Pub. Date: Nov. 2, 2023

(54) AUDIO SOURCE FEATURE SEPARATION AND TARGET AUDIO SOURCE GENERATION

(71) Applicant: SHURE ACQUISITION HOLDINGS, INC., Niles, IL (US)

(72) Inventors: Michael Lester, Buena Vista, CO (US); Dan Law, Glencoe, IL (US)

(21) Appl. No.: 18/309,441

(22) Filed: Apr. 28, 2023

Related U.S. Application Data
(60) Provisional application No. 63/336,067, filed on Apr. 28, 2022.

(51) Int. Cl. G10L 21/028

(52) U.S. Cl. CPC G10L 21/028

(57) ABSTRACT

Various embodiments of the present disclosure provide methods, apparatus, systems, devices, and/or the like for reducing defects of audio signal samples by using at least one of audio source feature separation machine learning models, audio generation machine learning models, and/or audio source feature classification machine learning models.

### CROSS-REFERENCE TO RELATED APPLICATIONS

The present application claims priority to U.S. Provisional Application Ser. No. 63/336,067, titled “AUDIO SOURCE FEATURE SEPARATION AND TARGET AUDIO SOURCE GENERATION,” filed Apr. 28, 2022, the contents of which are incorporated herein by reference in their entirety.

### BACKGROUND

Applicant has identified many deficiencies and problems associated with existing methods, apparatus, and systems related to processing audio signals. Through applied effort, ingenuity, and innovation, many of these identified deficiencies and problems have been solved by developing solutions that are configured in accordance with embodiments of the present disclosure, many examples of which are described in detail herein.

### BRIEF SUMMARY

In general, embodiments of the present disclosure provide methods, apparatus, systems, devices, and/or the like for reducing defects of audio signal samples by training and applying one or more of audio source feature separation machine learning models, audio generation machine learning models, and audio source feature classification machine learning models to captured audio signals.

The audio signal processing systems herein isolate targeted audio from other audio present in an audio signal sample by training and applying multiple models to the audio signal sample. An audio source feature separation model may be configured to generate or identify one or more isolate audio source features and one or more isolate source audio components from the audio signal sample. The isolate audio source features identified as associated with targeted or desired audio are then provided to an audio generation model that is configured to generate a target source generated audio sample based at least in part on the selected isolate source audio features.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure. It will be appreciated that the scope of the disclosure encompasses many potential embodiments in addition to those here summarized, some of which will be further described below and embodied by the claims appended herein.

### BRIEF DESCRIPTION OF THE DRAWINGS

Having thus described some embodiments in general terms, references will now be made to the accompanying drawings, which are not necessarily drawn to scale, and wherein:

FIG. 1 is an example system architecture within which embodiments of the present disclosure may operate.

FIG. 2 illustrates example flows performed by an example audio signal processing apparatus in accordance with embodiments of the present disclosure.

FIG. 3 illustrates an example audio source feature separation model in accordance with embodiments of the present disclosure.

FIG. 4 illustrates an example audio feature structure in accordance with one embodiment of the present disclosure.

FIG. 5 illustrates an example audio generation model that is configured to incorporate a single-channel generative neural network in accordance with one embodiment of the present disclosure.

FIG. 6 illustrates an example audio generation model that is configured to incorporate a multi-channel generative neural network in accordance with one embodiment of the present disclosure.

FIG. 7A illustrates an example architecture for use within an example audio source feature separation model according to one or more embodiments of the present disclosure.

FIG. 7B illustrates an example decoder unit for use within the example architecture depicted in FIG. 7A.

FIG. 7C depicts an example encoder unit for use within the example architecture depicted in FIG. 7A.

FIG. 8A illustrates an example architecture for use within an example audio source feature separation model according to one or more embodiments of the present disclosure.

FIG. 8B illustrates an example convolutional block for use within the example architecture depicted in FIG. 8A.

FIG. 9 illustrates an example architecture for use with one or more embodiments of the present disclosure.

FIG. 10 illustrates an example architecture for use with one or more embodiments of the present disclosure.

FIG. 11 depicts a schematic illustration of an example audio signal processing apparatus configured in accordance with one embodiment of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may embody many different forms and should not be construed as limited to the embodiments set forth herein. Rather, these embodiments are provided so that this disclosure will satisfy applicable legal requirements.

### Overview

Various embodiments of the present disclosure address technical problems associated with accurately, efficiently, and/or reliably suppressing noise and/or defects associated with an audio signal sample. Example audio processing systems are provided that are configured to provide improved denoising, echo cancellation, source separation, source localization, and to otherwise mitigate or remove audio defects from an audio signal.

Audio signal processing systems disclosed herein are configured to isolate audio components from an audio signal sample in order to identify and regenerate only targeted audio (for example, desired audio) and ignore other audio (for example, undesirable audio, extraneous audio sources, non-stationary noise, non-localized audio, and the like). An audio signal sample is a data construct that describes audio data or an audio data stream or portion thereof that is capable of being transmitted, received, processed, and/or stored, and an audio signal sample is captured by a set of audio sensors.

The audio signal processing systems herein isolate targeted audio from other audio present in an audio signal sample by training and applying multiple models to the audio signal sample. For example, an audio source feature separation model may be configured to generate or identify one or more isolate audio source features and one or more isolate source audio components from the audio signal sample.

Audio signal processing systems as discussed herein may be implemented as a microphone or part of a microphone, a digital signal processing (DSP) apparatus, and/or as software that is configured for execution on a laptop, PC, or other computing or audio device. Audio signal processing systems can further be incorporated into software that is configured for automatically processing speech from one or more microphones in a conferencing system (for example, an audio conferencing system, a video conferencing system, and the like). An audio signal processing system can be integrated within an inbound audio chain from remote participants in a conferencing system, or integrated within an outbound audio chain from local participants in a conferencing system.

The disclosed techniques enable an audio signal processing system to train and apply sophisticated machine learning models to both more efficiently and more effectively isolate targeted audio and ignore noise/defects from audio signal samples relative to manually configured techniques such as those involving traditional acoustic audio processing, acoustic beamforming, or other methods attempting to filter out or remove defects from the audio signal samples. That is, because techniques herein can completed ignore unwanted components of audio signal samples, techniques disclosed herein can isolate and regenerate targeted or desired audio without the need for reducing or suppressing undesired audio. Moreover, the disclosed techniques reduce the need for manual supervision of denoising/defect removal frameworks utilized in traditional audio signal processing systems, thus further improving efficiency and utility of the herein disclosed audio signal processing systems.

Example audio processing systems configured as discussed herein are configured to produce improved audio signals with reduced or eliminated noise even in view of exacting audio latency requirements. Such reduced noise may be stationary and/or non-stationary noise.

Improved audio processing system embodiments as discussed herein may employ a fewer number of computing resources when compared to traditional audio processing systems that are used for digital signal processing and denoising. Additionally or alternatively, improved audio processing systems described herein may be configured to deploy a smaller number of memory resources allocated to denoising, echo removal, source separating, source localizing, or beamforming of an audio signal sample. Improved audio processing systems are configured to improve processing speed of denoising, echo removal, source separating, source localizing, or beamforming operations and/or reduce a number of computational resources associated with applying machine learning models to such tasks. These improvements enable deployment of the improved audio processing systems discussed herein in microphones or other hardware/software configurations where processing and memory resources are limited, and/or where processing speed is important.

Improvements provided for by embodiments described herein further include, when used in tandem with localization to apply rules of spatial location to a room to determine what is targeted, creation of location zones within a room such that a physical room can be partitioned into multiple or virtual rooms. For example, a single microphone apparatus in a physical room may be configured to divide the physical room into quadrants and each of four different audio outputs consists only of desired audio associated with the appropriate quadrant). Further, when used in tandem with localization to create spatialized targeted audio in a physical room, embodiments described herein may enable recreation of a virtual acoustic presence on another end of a telephone or video-conference call. Additional applications of embodiments herein include classification of sub mixes such as all male voices versus all female voices, all loud sounds versus all quiet sounds, all noise sources versus all voice or speech sources, all room noises versus all non-room noises for ambience tracking or other virtual-reality applications, or the like.

### Example System Architecture for Implementing Embodiments of the Present Disclosure

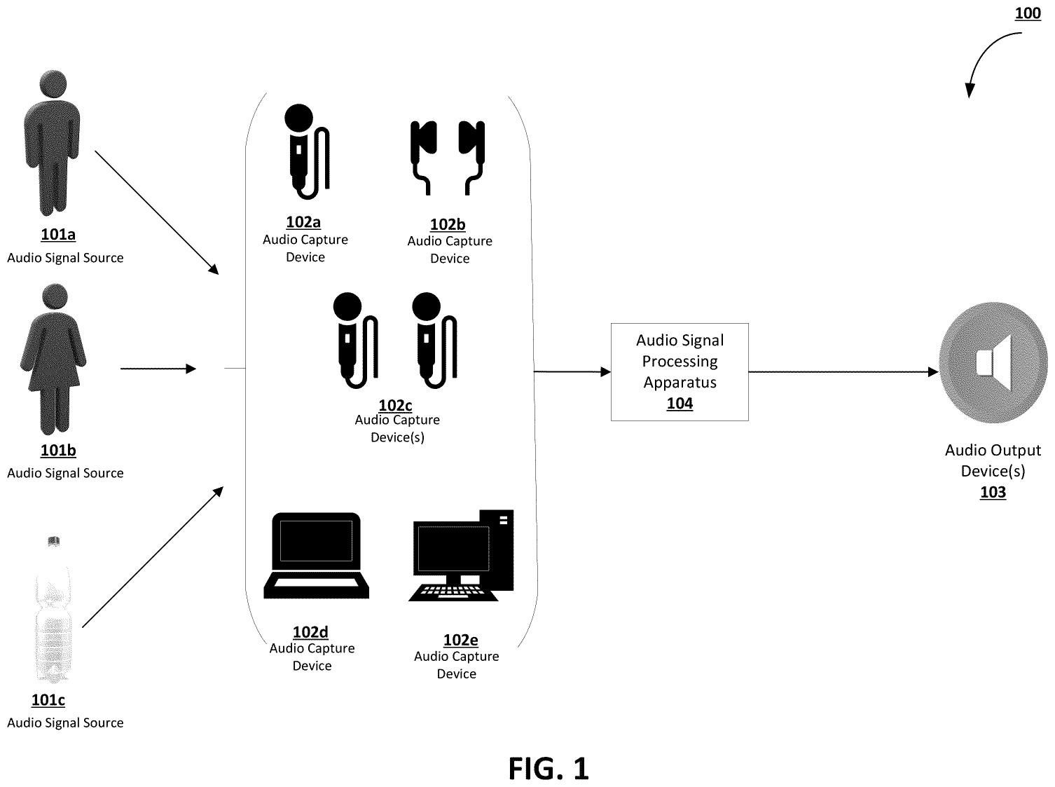

FIG. 1 is an example architecture 100 for performing the audio signal processing operations of the present disclosure. In the exemplary embodiment of FIG. 1, an audio signal processing apparatus 104 receives audio signal samples from a set of audio sensors 102a-e that are external to the audio signal processing apparatus 104 and provides target source generated audio samples to a set of audio output devices 103 that are external to the audio signal processing apparatus 104. It will be appreciated that at least one of the set of audio sensors 102a-e or the set of audio output devices 103 may be a part of (for example, not necessarily external to) the audio signal processing apparatus 104.

An audio signal sample may refer to a defined portion of an audio signal (for example, streaming audio data) that is made available for digital signal processing and denoising operations. The audio signal sample can be a time domain signal that represents one or more portions of the audio signal based on amplitude and time. For example, an audio signal sample may be configured as a 30 milliseconds data chunk of an audio signal stream. In some embodiments, the term audio signal sample describes n signals received by n audio capture or sensor devices, where each of the n audio capture or sensor devices may have a known location within an audio capturing environment and/or may have an unknown location within an audio capturing environment.

As another example, given a set of audio signal emitting devices in an audio capturing environment, each source component may describe audio data related to audio signals emitted by a different audio signal emitting device. When an audio signal sample includes n audio signals received by k audio capture or sensor devices, a source component may include audio data captured via two or more the n audio signals that are determined to be related to a particular audio emitting source. Given n audio signals, m per-signal audio source components are detected for each detected audio emitting source, and then the m per-signal audio source components for a particular audio emitting source may be combined to generate the source component for the particular audio emitting source, should the source component end up being considered targeted or desired.

An isolate audio source feature is an aspect or characteristic of an isolate source audio component of the audio signal sample. That is, an audio signal sample may be comprised of multiple isolate source audio components, where each isolate source audio component is associated with a particular audio source. An isolate source audio component may be associated with various isolate audio source features, which are aspects or characteristics of the isolate audio source component.

Referring back to FIG. 1, audio signal samples may emanate from one or more audio signal sources 101a-c and may be captured by the set of audio sensors 102a-e. One or more of the set of audio sensors 102a-e may be configured to capture sound waves generated by the one or more audio signal sources 101a-c, such as speech, vocalizations, singing, music, and/or the like from human sources 101a and 101b. One or more of the set of audio sensors 102a-e may also capture sound waves from one or more undesirable audio signal sources, such as noise emanating from undesirable sources. An example of noise may be non-stationary noise generated by as a result of water bottle 101c (for example, an undesirable source) being crushed.

An audio sensor of the set of audio sensors or capture devices 102a-e may be any device configured to capture sounds waves. The set of audio sensors or capture devices 102a-e may include one or more microphones (including wireless or wired microphones), array microphones, in-ear monitors, headphones, laptops, desktops, mobile phones, tablets, notebooks, wireless audio receivers, audio conferencing microphones, and/or the like.

Any of the devices of the set of audio sensors 102a-e may be configured to operate with one or more computer program applications, plug-ins, and/or the like. For example, a desktop device may be configured to execute a video conference computer program application. Wireless audio sensors typically include antennas for transmitting and receiving radio frequency (RF) signals which contain digital or analog signals, such as modulated audio signals, data signals, and/or control signals. A wireless audio receiver may be configured to receive RF signals from one or more wireless audio transmitters over one or more channels and corresponding frequencies. For example, a wireless audio receiver may have a single receiver channel so that the receiver is able to wirelessly communicate with one wireless audio transmitter at a corresponding frequency.

As another example, a wireless audio receiver may have multiple receiver channels, where each channel can wirelessly communicate with a corresponding wireless audio transmitter at a respective frequency. The set of audio output devices 103 may include one or more devices configured to transmit or broadcast audio signals. Examples of audio output devices 103 include wireless audio transmitters that are configured to transmit a signal, carrier wave, or the like, to one or more audio receivers.

The audio output devices 103 are configured to receive target source generated audio samples from the audio signal processing apparatus 104. The audio output devices 103 may be further configured to broadcast or otherwise transmit audio signals corresponding to the target source generated audio samples using one or more audio transmitters.

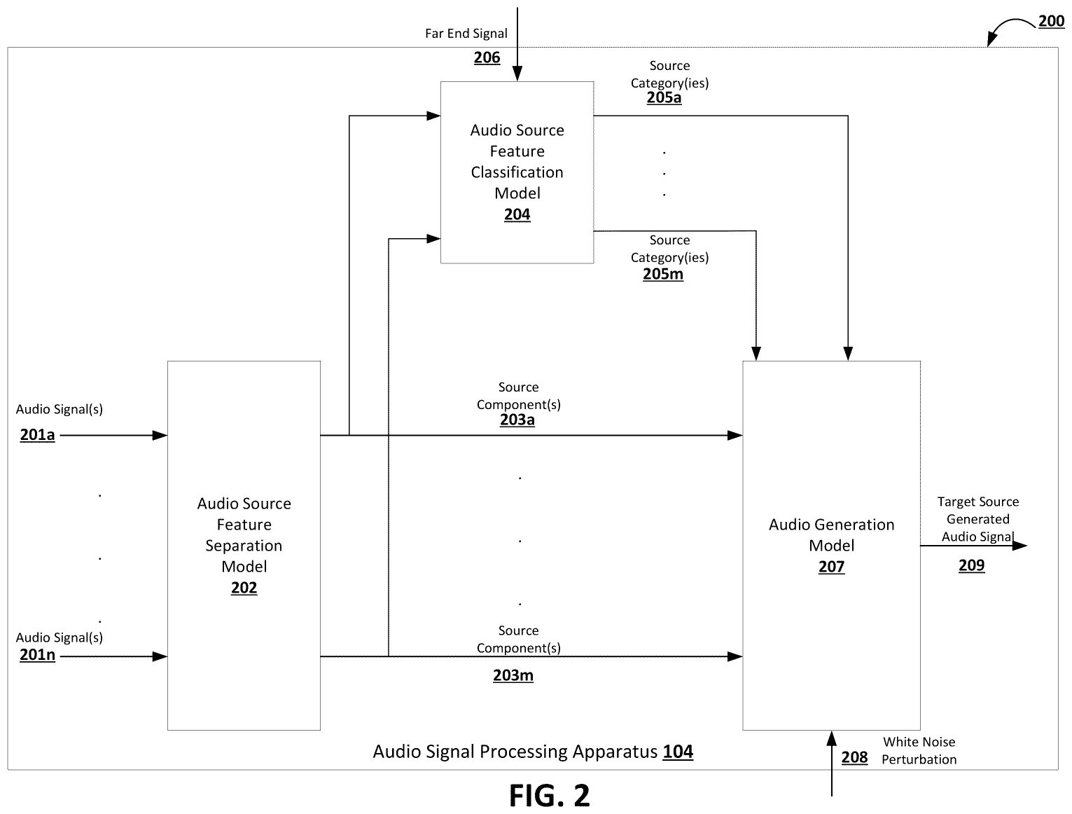

The audio signal processing apparatus 104 may be configured to receive audio signal samples from the set of audio sensors 102 using an input/output interface, provide each audio signal sample to an audio source feature separation machine learning model (shown as item 202 in FIG. 2) that is configured to generate a one or more isolate source audio features and one or more isolate source audio components from each audio signal sample, provide one or more isolate source audio features to an audio generation machine learning model (shown as item 207 in FIG. 2) that is configured to generate a target source generated audio sample for each audio signal sample based at least in part on the one or more isolate source audio features, and provide the target source generated audio samples to the set of audio output devices 103 using the input/output interface.

### Example Operations of Embodiments of the Present Disclosure

FIG. 2 is a data flow diagram of an example process 200 for determining or generating a target source generated audio sample 209. The process 200 includes audio signal processing apparatus 104 receiving an audio signal sample 201 comprising a set of n audio signals 201a-201n from a set of n audio capture or sensor devices (not shown in FIG. 2). An audio source feature separation model 202 is configured to process the n audio signals 201a-201n to generate m source components 203a-203m of the audio signal sample 201. The m source components 203a-203m may include one or more isolate source audio features and/or one or more isolate source audio components. The audio source separation machine learning model 202 may be configured to generate or extract a feature set for each of n signals described by an input audio signal sample, generate combined feature data based on each feature set of the n feature sets for the n captured signals, and process the combined feature data to generate the m source components.

As mentioned, an audio signal sample is made up of a plurality of isolate audio source components, where each isolate audio source component of the audio signal sample is associated with a particular audio source. Each isolate audio source component is associated with one or more isolate audio source features, which are aspects or characteristics of the isolate audio source component.

The audio source feature separation model (or audio source feature separation machine learning model) is configured to identify independent features (isolate audio source features) of an isolate source audio component in a manner that leads to a predicted inference that the audio source component describes audio signals emitted by a targeted distinct source. That is, the audio source feature separation model outputs an isolate audio source feature that represents a predicted inference that an isolate audio source component (associated with the isolate source audio component) describes: (i) audio signals emitted by a targeted source (e.g., a distinct person or speaker, a distinct audio transmitter device, and/or the like in source separation applications), (ii) audio signals emitted proximate a targeted location (e.g., in source localization applications), and (iii) audio signals emitted proximate a targeted far end source (for example, in echo cancellation applications).

Not only is the audio source feature separation model configured to separate the isolate source audio components of an audio signal sample, the audio source feature separation model also identifies features of the isolate source audio components in order to generate the predicted inference that a given isolate source audio component describes audio signals emitted by a desired or targeted source (as opposed to undesirable or non-targeted). That is, isolate source audio components of an audio signal sample may be identified or isolated, and then the audio source feature separation model determines, based on the isolate audio source features of the isolate source audio components, whether the isolate source audio component is associated with a desired source. An isolate source audio component that is determined to be associated with a desired or target source is a target source audio component.

In some examples, the audio source feature separation model is configured to first apply audio source separation which separates combined audio into individual source components (for example, isolate audio source components). These audio source components are then transformed into features (for example, isolate audio source features) that describe the audio source components yielding a predicted inference feature set of targeted distinct sources. In some examples, the audio source feature separation model is configured to transform the combined audio into features that describe the audio source components (for example, without first separating the combined audio).

As described above, m source components 203a-203m are generated by the audio source feature separation model 202 via processing then audio signals 201a-201n of the received audio signal sample 201. To generate the m source components 203a-203m, the audio source feature separation model 202 uses at least one of one or more non-invertible transform layers that are configured to generate or extract a feature set for each of n signals described by an input audio signal sample, one or more feature transformation layers that are configured to generate combined (or extracted) feature data based on transformation of one or more of the n feature sets for then captured signals, one or more convolutional machine learning layers that are configured to process the combined or extracted feature data to generate a convolutional representation of the combined feature data, and one or more discriminative machine learning layers that are configured to process the convolutional representation to generate or identify one or more isolate source audio components.

The audio source feature separation model 202 may comprise a convolutional neural network, such as a two-dimensional convolutional neural network that is configured to process two-dimensional feature data (e.g., two-dimensional data describing an amplitude of a captured audio signal for a particular audio sensor at a particular time, where a first dimension of the two-dimensional data is associated with time variations and a second dimension of the two-dimensional data is associated with sensor variations) for an audio signal sample to generate one or more isolate source audio components from the audio signal sample, or a three-dimensional convolutional neural network model that is configured to process three-dimensional feature data (e.g., three-dimensional data describing two-dimensional features of a captured audio signal for a particular audio sensor at a particular time, where a first dimension of the three-dimensional data is associated with time variations, and a second dimension and a third dimension of the three-dimensional data is associated with the dimensions of the captured audio signal features) for an audio signal sample to generate or identify one or more isolate source audio components from the audio signal sample.

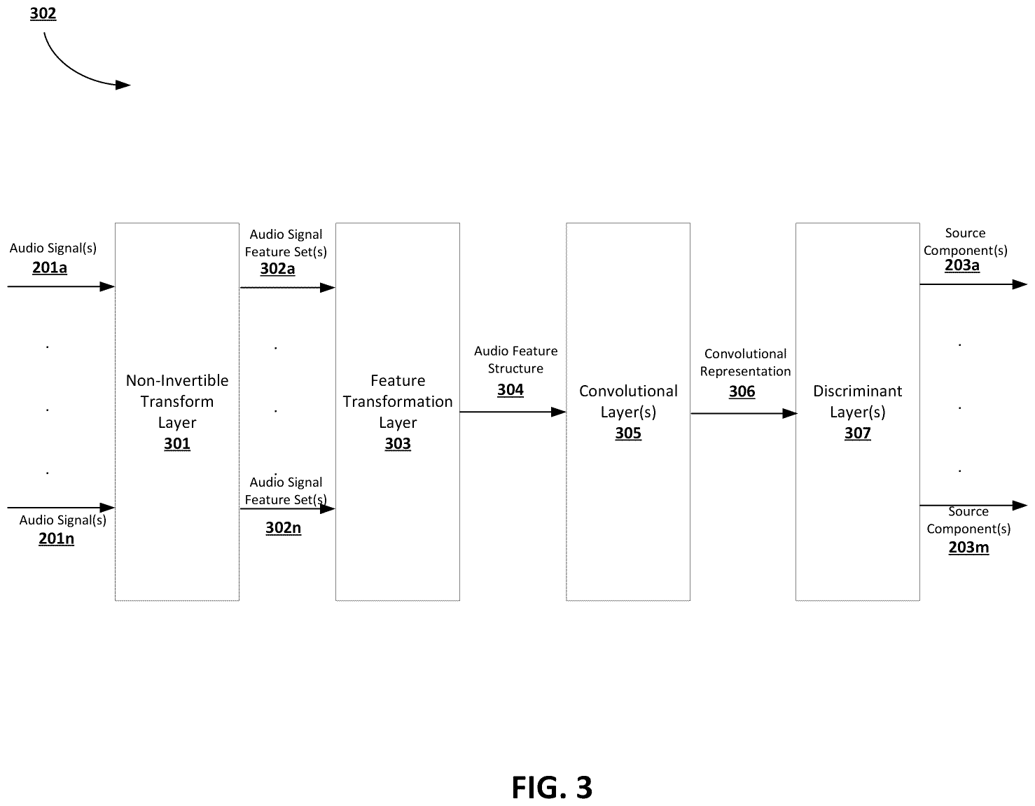

An operational example of an audio source feature separation model 202 is depicted in FIG. 3. The terms “audio source feature separation machine learning model” and “audio source feature separation model” refer to a data construct that describes defined operations of a machine learning model that is configured to generate one or more isolate source audio features and/or one or more isolate source audio components from an audio signal samples. Operations of the audio source feature separation model may be performed by an audio signal processing apparatus.

As depicted in FIG. 3, the audio source feature separation model 202 comprises a non-invertible transform layer 301 that is configured to perform one or more feature extraction or non-invertible transform operations on the n audio signals 201a-201n to generate n audio signal feature sets 302a-302n for each of then audio signals 201a-201n such that the n audio signal feature sets 302a-302n is in non-invertible form. The non-invertible n audio signal feature sets 302a-302n can provide detailed information about the audio signal sample that aids in source separation that an invertible transform is unable to provide.

Examples of feature extraction or non-invertible transform operations that may be performed on an audio signal may include, without limitation, generating a mel-frequency cepstrum (MFC) representation of the audio signal, generating a magnitude-only spectrum of the audio signal, generating a cochleargram of the audio signal, generating a cochlea neural transformation of the audio signal, or the like.

Each audio signal feature set 302a-302n may be a one-dimensional data structure that describes a set of amplitude values, where each amplitude value is associated with a time designation. Each audio signal feature set 302a-302n may be a two-dimensional data structure that is determined based on at least one of a real spectrogram of the corresponding audio signal, a complex spectrogram of the corresponding audio signal, an MFC representation of the corresponding audio signal, a cochleargram of the corresponding audio signal, and/or the like.

As further depicted in FIG. 3, the audio source feature separation model 302 further comprises a feature transformation layer 303 that is configured to combine, transform, or extract one or more of the n audio signal feature sets 302a-302n to generate an audio feature structure 304. The combination, transformation, or extraction of one or more of the n audio signal feature sets 302a-302n may result in a representation of extractions or combinations of the n audio signal feature sets in a resulting audio feature structure 304. When each of the n audio signal feature sets 302a-302n is a one-dimensional structure, after combining or transforming the n audio signal feature sets 302a-302n into the audio feature structure 304, the audio feature structure 304 is a two-dimensional structure, with an added dimension associated with sensor/signal variations. In some embodiments, when each of the n audio signal feature sets 302a-302n is a two-dimensional structure, after combining, extracting, or transforming the n audio signal feature sets 302a-302n into the audio feature structure 304, the audio feature structure 304 is a three-dimensional structure, with an added dimension associated with sensor/signal variations.

In a case of transforming single step mixed audio to a distinct audio feature set, the mixed audio in a single channel, or a collection of mixed audio from a set of sensors, are input to the audio source feature separation model. The desired set of distinct audio features are also provided to the model during training as a ground truth. The audio source feature separation model is trained by providing a loss function comparing the model output to the desired feature ground truth; the model is trained until a sufficiently accurate output is obtained.

In a case of feature transformation involving dividing an audio signal into individual isolate audio source components, two models may be trained independently or dependently; however, in either case the loss function of each model is trained independently. The first of the two models is an audio source separation model where the mixed audio in a single channel, or a collection of mixed audio from a set of sensors, are input to the model. The desired audio streams (time domain or frequency domain) are also provided to the model training as a ground truth. The model is trained by providing a loss function comparing the model output to the audio ground truth until a sufficiently accurate set of separated audio outputs are obtained. In the second stage, the individual audio outputs are in the input to a second of the two models, which is a feature generation model. The desired set of features that describe the audio input is also provided to the model training as a ground truth. The model is trained by providing a loss function comparing the model feature output to the explicitly calculated features and is trained until a sufficiently accurate output is obtained. These two model trainings can happen independently where the first model is trained until it converges and is frozen and the outputs of a fully trained model are provided to the second model. The two models may also be trained together where the output of the first model as is during training and converging is provided to the input of the second model.

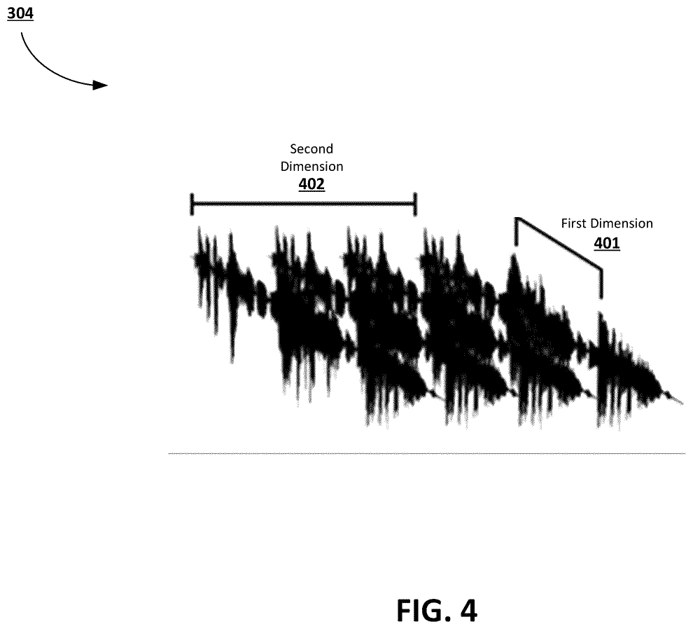

An operational example of a combined, extracted, or transformed audio feature structure 304 is depicted in FIG. 4. The depicted audio feature structure 304 comprises two dimensions, where a first dimension 401 describes a sample window for each audio channel associated with an audio signal of the n audio signals 201a-201n, as well as a second dimension 402 that describes variations across the audio channels associated with the n audio signals 201a-201n.

Returning to FIG. 3, the audio source feature separation model 202 further comprises a set of convolutional layers 305 that are configured to process the combined, extracted, or transformed audio feature structure 304 to generate a convolutional representation 306 of the audio feature structure 304. When the audio feature structure 304 is a two-dimensional structure, the set of convolutional layers 305 perform operations corresponding to a two-dimensional convolutional operation. When the audio feature structure 304 is a three-dimensional structure, the set of convolutional layers 305 perform operations corresponding to a three-dimensional convolutional operation. In some embodiments, the convolutional operations performed by the set of convolutional layers 305 employ kernels that map portions of the audio feature structure 304 to values spanning a range of time (or frequency and time, or non-invertible transform domain and time) and a range of space (sensor devices).

The convolutional operations are applied to a degree that covers the maximum time difference between received signals across the largest spatial extent of the audio capture or sensor devices (for example, the time it takes a signal to propagate between the furthest sensors, in number of samples in time). In some embodiments, the set of convolutional layers 305 perform convolutional operations of a convolutional U-Net. In some embodiments, the set of convolutional layers 305 perform convolutional operations of a fully-convolutional time-domain audio separation network (Conv-TasNet).

As further depicted in FIG. 3, the audio source feature separation model 202 further comprises a set of discriminant layers 307 that are configured to process the convolutional representation 306 to generate the m source components 203a-203m. In some embodiments, the set of discriminant layers 307 perform operations of a set of fully-connected neural network layers. In some embodiments, the set of discriminant layers 307 perform operations of a machine learning model employing a vector symbolic architecture.

Returning to FIG. 2, process 200 continues when the audio source feature separation model 202 inputs the m source components 203a-203m to an audio source feature classification model 204 that is configured to generate m source categories 205a-205m comprising a source category for each source component. A source component may be an audio source component, which may include a corresponding audio signal and/or a generated audio feature as determined by the audio source feature separation model 202. Alternatively, a source component may include only the generated audio feature (e.g., without the audio signal). The terms “audio source feature classification machine learning model” and “audio source feature classification model” refer to a data construct that describes defined operations of a machine learning model that is configured to generate a source category for a source audio component based on features associated with the source audio component. The operations of the audio source feature classification model are performed by an audio signal processing apparatus.

The audio signal processing apparatus may be configured to provide one or more of the isolate source audio feature(s) and/or the isolate source audio component(s) to the audio source feature classification model to classify the isolate source audio feature(s) and/or the isolate source audio component(s) into one or more audio source categories.

The audio source feature classification model 204 may comprise one or more neural network layers (for example, one or more fully-connected neural network layers) that are configured to process one or more features of an isolate audio source component and an acoustic far end signal 206 to generate a source category for the source component. The audio source feature classification model 204 may comprise a set of acoustic far end signal transformation layers that are configured to perform one or more non-invertible transformation operations on the acoustic far end signal 206 to generate far-end signal feature data. The audio source feature classification model 204 may further comprise a set of classification layers that are configured to process the far-end signal feature data and an input source component to generate a source category for the input source component.

The set of classification layers are configured to generate, for each potential source category of a set of potential source categories, a classification score that describes a likelihood that the source component belongs to the potential source category, with the source category for the input source component being selected as the potential source category having a highest classification score. In some embodiments, the audio source categories include at least a desired audio source category and undesired audio source category.

The audio source feature classification model 204 may form a subset of convolutional layers of the above described audio source feature separation model 202. The audio source feature classification model 204 may be a distinct model positioned as an intermediary between the audio source feature separation model 202 and the audio generation model 207.

The audio source feature classification model 204 may be configured to determine an audio source category for an isolate audio source component, and determine that an isolate audio source component is associated with targeted or desired audio based on the determined audio source category being designated as a target audio source category. When more than one isolate audio source component has a common audio source category that is designated as the target audio source category, each of the group of isolate audio source components may be deemed as associated with separate and independent targeted audio sources.

Examples of feature classifications associated with an audio source feature classification model may include voice audio versus noise, stationary noise versus non-stationary noise, male speaker versus female speaker, a voice is associated with a same source as previously identified in time versus a new source (for example, the model learns who is speaking and channelizes audio source components accordingly), near-end source versus far-end source (for example, to not reconstruct echo), or a speaker facing toward a microphone versus away from the microphone. Furthermore, feature classification associated with an audio source feature classification model may include individual identification of speaker voices. For example, a voiceprint repository may be configured to store one or more biometric voice prints and/or voice profiles for one or more users. The audio source feature classification model may be configured to compare audio source components to identify individual speakers. As such, feature classifications may include a list of desired speakers and undesired speakers such that audio from undesired speakers may be removed.

The audio source feature classification model 204 may comprise a convolutional autoencoder network, a U-net, a full recurrent network comprised of LSTMs, GRUs, or the like. The audio source feature classification model 204 may be trained using component features as input, where inferred output is the desired class(es), ground truth is the actual classes, and the model is trained to minimize error between the ground truth and the inferred output.

The isolate source audio component and/or the isolate audio source features are then provided to an audio generation model that is configured to generate a target source generated audio sample based at least in part on the selected isolate source audio component or features. The isolate source audio component or features may be identified, by the audio source feature separation model, as targeted and therefore desirable for regeneration; this is in contrast to the isolate source audio component being identified as non-targeted or undesirable and therefore not a candidate for regeneration (or, is identified as a candidate for being ignored). The isolate source audio component and/or isolate source audio features may, in some examples, be provided to one or more audio source feature classification models for classification into one or more source categories as an intermediary step prior to application of the audio generation model.

The process 200 continues when the audio source feature separation model 202 provides the m source components 203a-203m to an audio generation model 207. The audio source feature classification model 204 may also provide the m source categories 205a-205m for the m source components 203a-203m to the audio generation model 207. The audio generation model 207 is then configured to process the m source components 203a-203m and the m source categories 205a-205m for the m source components 203a-203m along with a white noise perturbation 208 to generate a target source generated audio sample 209.

The terms “audio generation machine learning model” and “audio generation model” refer to a data construct that describes defined operations of a machine learning model that is configured to generate a target source generated audio sample based on one or more isolate source audio components and/or one or more isolate source audio features of an audio signal sample, where the one or more isolate source audio components and/or one or more isolate source audio features have been identified as being associated with targeted or desired audio. The operations of the audio generation model are performed by an audio signal processing apparatus.

The audio generation model may comprise one or more feature engineering layers that are configured to apply audio component processing operations on an isolate source audio component to generate a set of audio component features, and one or more generative neural network layers that are configured to process the set of audio component features (optionally along with a white noise perturbation input) to generate the target source generated audio sample.

The audio generation model may additionally or alternatively comprise an isolate audio source feature transformation layer that is configured to determine audio source features associated with a source category that is designated to be a target category, combine all audio source features that are designated to be associated with target source categories to generate a target audio source component, and perform one or more audio component processing operations on isolate audio source features to generate a modified isolate audio source feature set for an associated isolate audio source component.

Examples of audio component processing operations comprise automatic gain control (AGC) operations, one or more audio equalization operations, one or more audio compression operations, one or more audio component processing operations that are configured to transform a non-invertible feature (for example, as output from an audio source feature separation model described herein) to an enhanced non-invertible feature prior to generation, and/or the like.

The audio generation model is trained to take non-invertible feature inputs (for example, isolate audio source features) and generate audio frames (time or frequency domain) as output. The audio generation model is configured to learn how to generate audio output using feature inputs that do not have an explicit mathematical means of using the features to recreate the input to the feature extractor accurately.

The audio generation model may be a generator adversarial network (GAN). A GAN may include a single input-output during inference, where the features are the input and the audio is the output. The GAN may include three inputs during training which are features, the original audio that was used to create those features, and other real or actual audio for a discriminator to compare generated audio to real or actual audio. In such examples, a generator of the audio generator model attempts to create the generated audio from the features and a discriminator of the model attempts to determine if the audio generated is real (actual) or generated. Each of the generator and discriminator is adapted to do its job as best as possible; the GAN is considered converged and functional when the discriminator is unable to discern whether the input (of generated audio from the generator) is real (or actual) or fake (or generated by the generator).

The audio generation model may alternatively include a model that takes input of one domain (for example, features) and explicitly transforms it to another domain (for example, audio). Such a model may include, without limitation, a convolutional autoencoder, or the like. The model may be provided with features as an input to the model, actual audio as ground truth input during training, and it outputs actual audio inferred from the features. At each training step, the output is compared to the ground truth and it is trained to recreate the original audio with minimal error. While such a model is referred to as generating audio, the model is actually transforming from a non-invertible feature domain to an audio domain rather than generating audio based on its own weights and using a white noise as input.

The audio generation model 207 may be configured to determine, based on the m source categories 205a-205m for the m source components 203a-203m, one or more target-designated isolate audio source components of the m source components 203a-203m. Afterward, the audio generation model 207 is configured to combine the one or more target-designated isolate audio source components into a combined target audio source component, generate combined target audio source component feature data for the target audio source component, and process the combined target audio source component feature data using a generative neural network to determine the target source generated audio sample 209.

The audio generation model 207 may be configured to generate a source generated audio sample for each of the m source components 203a-203m using a multi-channel generative neural network. Afterward, the audio generation machine learning model 207 is configured to select, based on the m source categories 205a-205m for the m source components 203a-203m, a subset of the source generated audio samples that are associated with one or more target audio source components of the m source components 203a-203m. Afterward, the audio generation machine learning model 207 is configured to combine the source generated audio samples in the determined subset to generate the target source generated audio sample 209.

The audio signal processing system is configured to ultimately output the target source generated audio sample to one or more audio output devices. Accordingly, only target (or desired) audio from an audio signal sample is isolated (or undesired), identified, regenerated, and provided to downstream audio output devices. That is, the target source generated audio sample represents an approximation and enhancement of the audio signal sample without undesired signals that were present in the audio signal sample.

In some examples, an audio signal sample may be associated with an isolate source audio component associated with a single source, while in other examples the audio signal sample may be associated with a combination of isolate source audio components (associated with multiple isolate component sources). Because the target source generated audio sample or output includes only the target audio from the audio signal sample, the resulting target source generated audio sample or output may then be comprised of audio associated with fewer components than the audio signal sample.

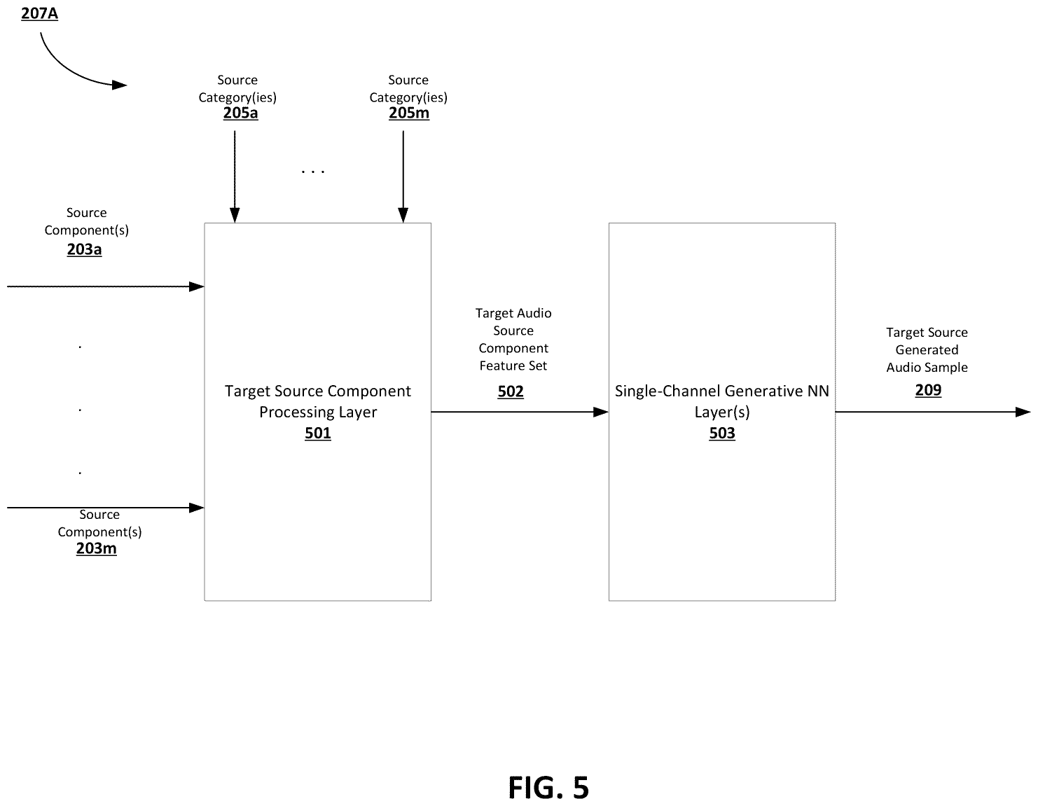

An operational example of an example audio generation model 207A is depicted in FIG. 5. As depicted in FIG. 5, the audio generation model 207A comprises a target audio source component processing layer 501 that is configured to combine all source components that are designated to be associated with target source categories to generate a target audio source component, and perform one or more audio component processing operations on the target audio source component to generate a target audio source component feature set 502 for the target audio source component. Examples of audio component processing operations comprise automatic gain control (AGC) operations, one or more audio equalization operations, one or more audio compression operations, one or more audio component processing operations that are configured to transform a non-invertible feature (for example, as output from an audio source feature separation model described herein) to an enhanced non-invertible feature prior to generation, and/or the like.

As further depicted in FIG. 5, the audio generation model 207A further comprises a set of single-channel generative neural network layers 503 that are collectively configured to process the target audio source component feature set 502 to generate the target source generated audio sample 209. The single-channel generative neural network layers 503 may be configured to process the target audio source component feature set 502 and the white noise perturbation 208 to generate the target source generated audio sample 209. In some embodiments, the single-channel generative neural network layers 503 comprise one or more decoder layers that trained as part of an encoder-decoder architecture along with a set of audio encoder layers.

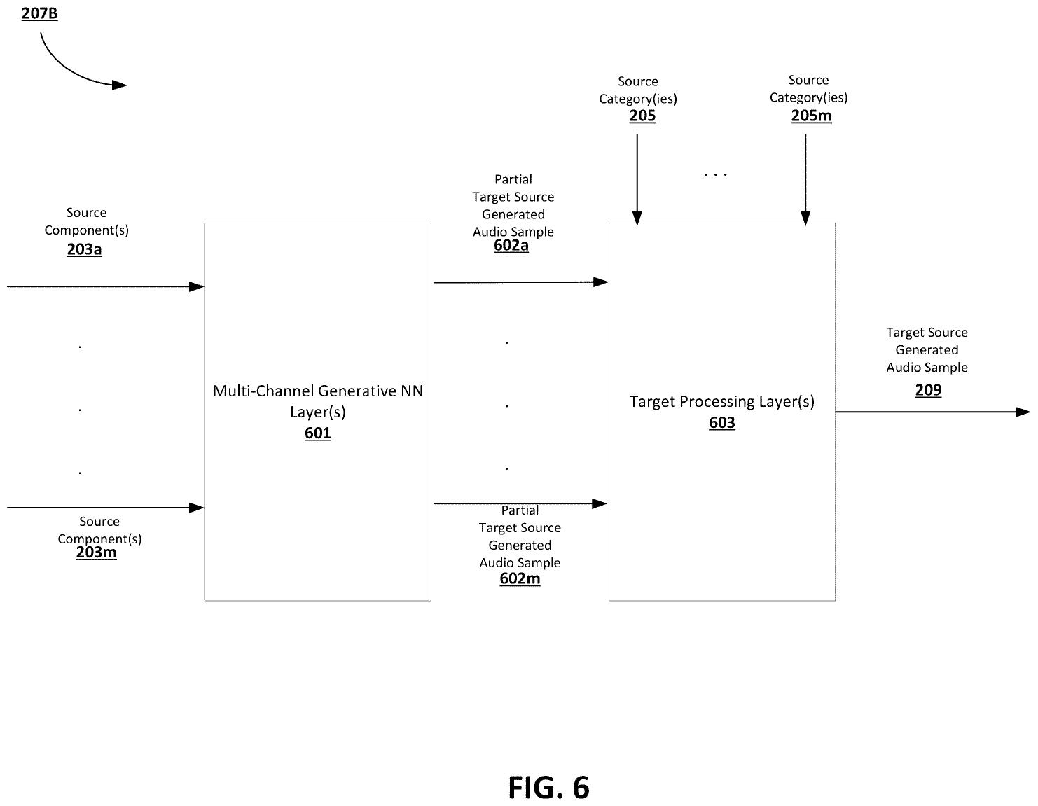

Another operational example of a particular audio generation model 207B is depicted in FIG. 6. As depicted in FIG. 6, the audio generation model 207B comprises a set of multi-channel generative neural network layers 601 that are configured to process each source component of the m source components 203a-203m in order to generate m partial target source generated audio samples 602a-602m, where each target source generated audio sample is associated with a respective source component and is a generated version of the source component. In some embodiments, the audio generation model 207B is configured to process m source components 203a-203m along with the white noise perturbation 208 to generate the m partial target source generated audio samples 602a-602m. In some embodiments, the multi-channel generative neural network layers 601 comprise one or more decoder layers that trained as part of an encoder-decoder architecture along with a set of audio encoder layers.

As further depicted in FIG. 6, the audio generation model 207B comprises a set of target processing layers 603 that are configured to determine a target-designated partial target source generated audio samples from the m partial target source generated audio samples 602a-602m that are associated with the target-designated source categories, combine all of the target-designated partial target source generated audio samples to generate a combined target source generated audio sample, and perform source component processing operations on the combined target source generated audio sample to generate the target source generated audio sample 209. Examples of source component processing operations comprise automatic gain control (AGC) operations, one or more audio equalization operations, one or more audio compression operations, one or more audio component processing operations that are configured to transform a non-invertible feature (for example, as output from an audio source feature separation model described herein) to an enhanced non-invertible feature prior to generation, and/or the like.

Once generated, the target source generated audio sample 209 can be transmitted to one or more audio output devices for transmission and/or broadcasting using the audio output devices. Examples of audio output devices 103 include wireless audio transmitters that are configured to transmit a signal, carrier wave, or the like towards one or more audio receivers. In some embodiments, the audio output devices 103 are configured to receive target source generated audio samples from the audio signal processing apparatus 104 and broadcast audio signals corresponding to the target source generated audio samples.

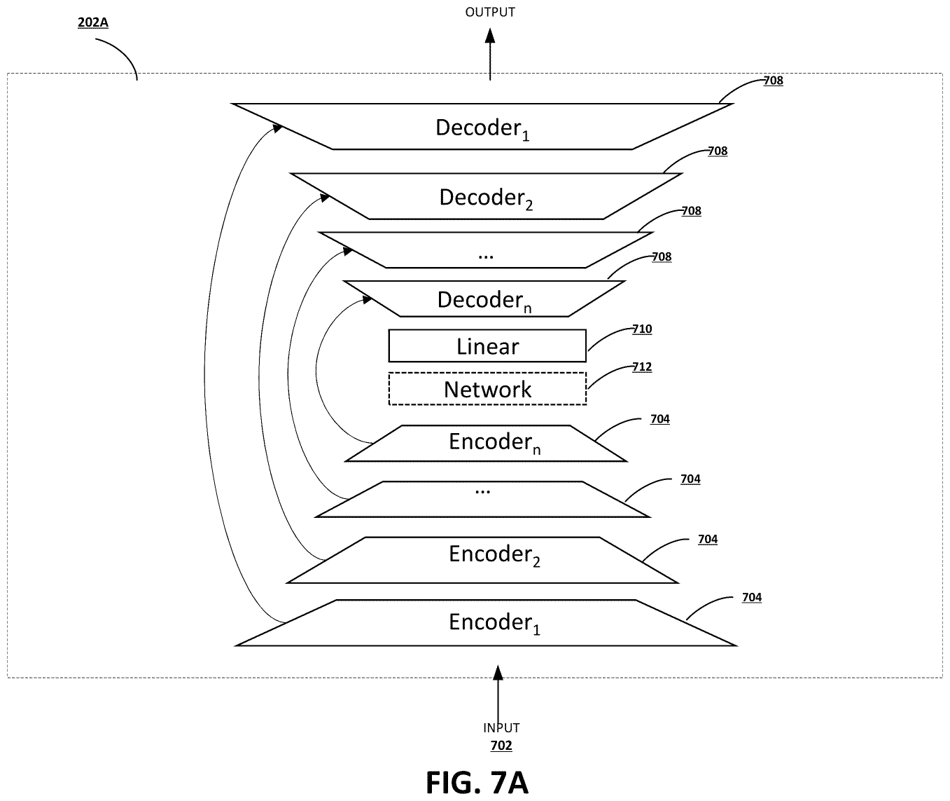

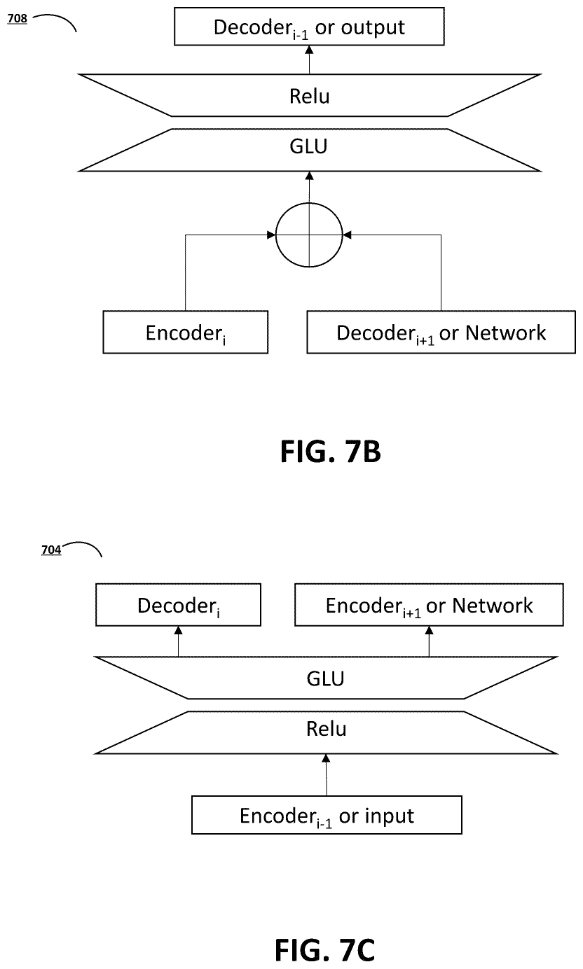

FIG. 7A illustrates an example architecture for use within an example audio source feature separation model 202A according to one or more embodiments of the present disclosure. FIG. 7B illustrates an example decoder unit for use within the example architecture depicted in FIG. 7A. FIG. 7C depicts an example encoder unit for use within the example architecture depicted in FIG. 7A. The example audio source feature separation model 202A can be a fully convolutional deep neural network (DNN). In an aspect, the audio source feature separation 202A can include a set of convolutional layers configured in a U-Net architecture. In another aspect, the audio source feature separation model 202A can include an encoder/decoder network structure with skip connections. In an embodiment, input 702 is provided to the audio source feature separation model 202A. The audio source feature separation model 202A may include a set of encoders 704 and a set of decoders 708 linked with skip connections. The input 702 may correspond to the set of n audio signals 201a-201n from a set of n audio capture or sensor devices, for example, and the output of the audio source feature separation model 202A may include an estimate for each source.

Shown in FIG. 7C, an encoder unit 704 of the audio source feature separation model 202A comprises a set of stacked convolutional blocks, including a convolution with rectified linear unit (ReLU) activation followed by a convolution with gated linear units (GLU) as an activation function. In some examples, a network 712 (for example, a bidirectional LSTM) may be used in conjunction with a linear layer 710. Shown in FIG. 7B, a decoder unit 708 of the audio source feature separation model 202A comprises stacked convolution blocks, including a convolution with gated linear units (GLU) followed by a convolution with rectified linear unit (ReLU) activation. Each gated linear unit can include a convolutional layer gated by another parallel convolutional layer with a sigmoid layer configured as an activation function. Additionally or alternatively, batch normalization and/or parametric rectified linear unit activation can be performed after the gating.

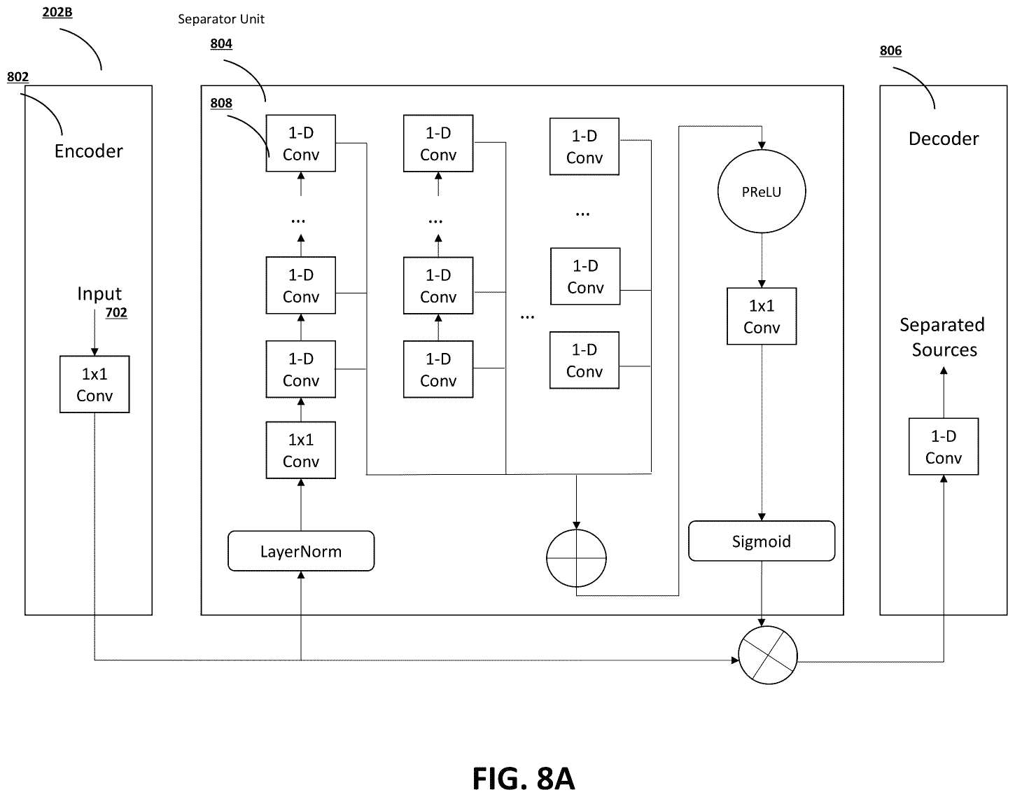

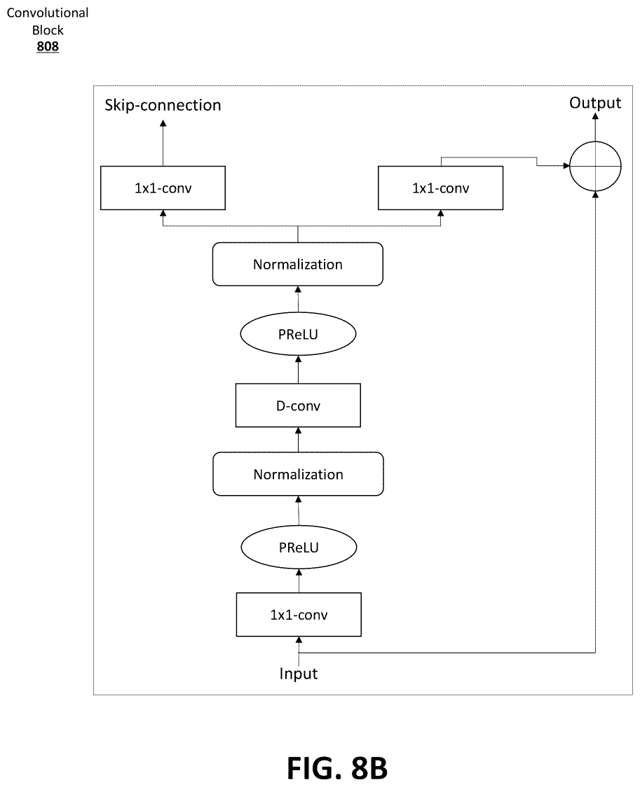

FIG. 8A illustrates an example architecture for use within an example audio source feature separation model 202B according to one or more embodiments of the present disclosure. FIG. 8B illustrates an example convolutional block for use within the example architecture depicted in FIG. 8A. In FIG. 8A, an example audio source feature separation model 202B comprises an encoder unit 802, a separator unit 804, and a decoder unit 806. The encoder unit 802 may be configured to map a segment of the input 702 to a high-dimensional representation. The separator unit 804 may be configured to calculate a multiplicative function (for example, a mask) for each target source. The decoder unit 806 may be configured to reconstruct the source waveform from the masked features provided by the separator unit 804. The separator unit 804 includes one dimensional convolutional blocks 808 consisting of a 1×1 convolution (1×1 cony) operation followed by a depth-wise convolution (D-conv) operation, with nonlinear activation function (parametric rectified linear unit or PReLU) and normalization added between each two convolution operations. A first linear 1×1 cony operation block may serve as a residual path and a second linear 1×1 cony operation block may serve as a skip-connection path. Additionally or alternatively, the example architecture depicted in FIG. 8A and/or FIG. 8B may be used as part of the audio source feature classification model.

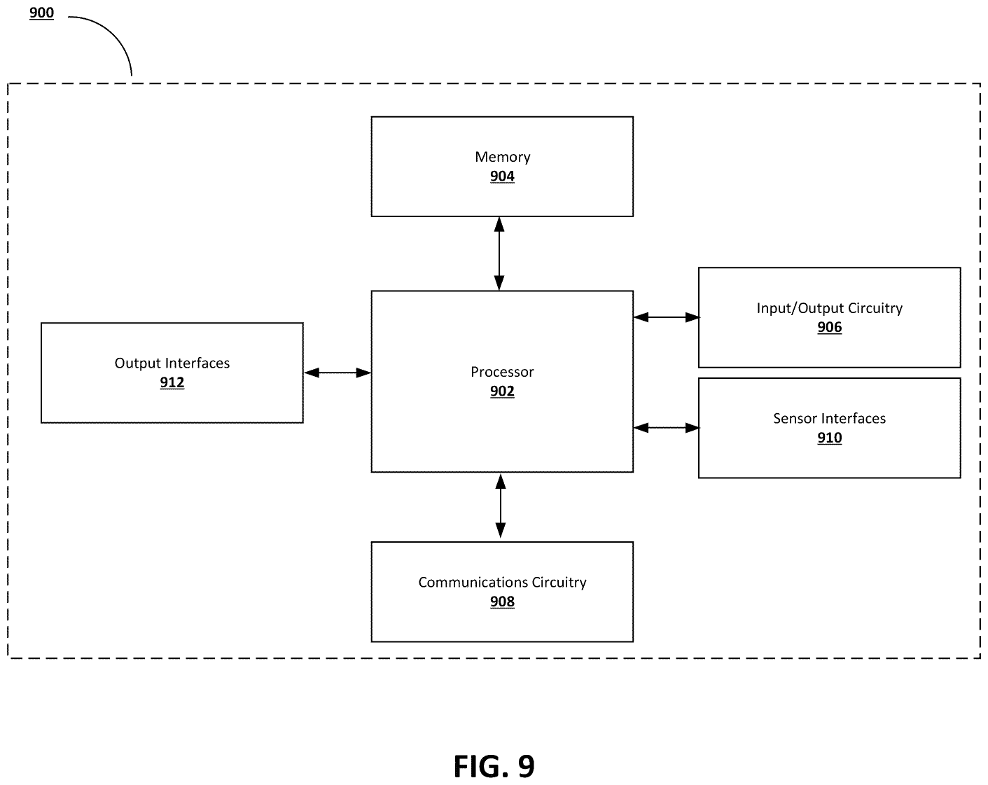

FIG. 9 illustrates an example architecture that may be used with one or more embodiments of the present disclosure. As shown in FIG. 9, an example model may include a plurality of convolutional gated linear units (ConvGLUs) 1001a-1001f, residual blocks 1002a-e, exponential linear units (ELUs) 1003a-e, and maximum pooling blocks 1004a-e. A repeating sequence of a ConvGLU, residual block, ELU, and maximum pooling block may be used along with linear layer 1005, an ELU 1006, and a liner layer 1007 to identify and classify each target source.

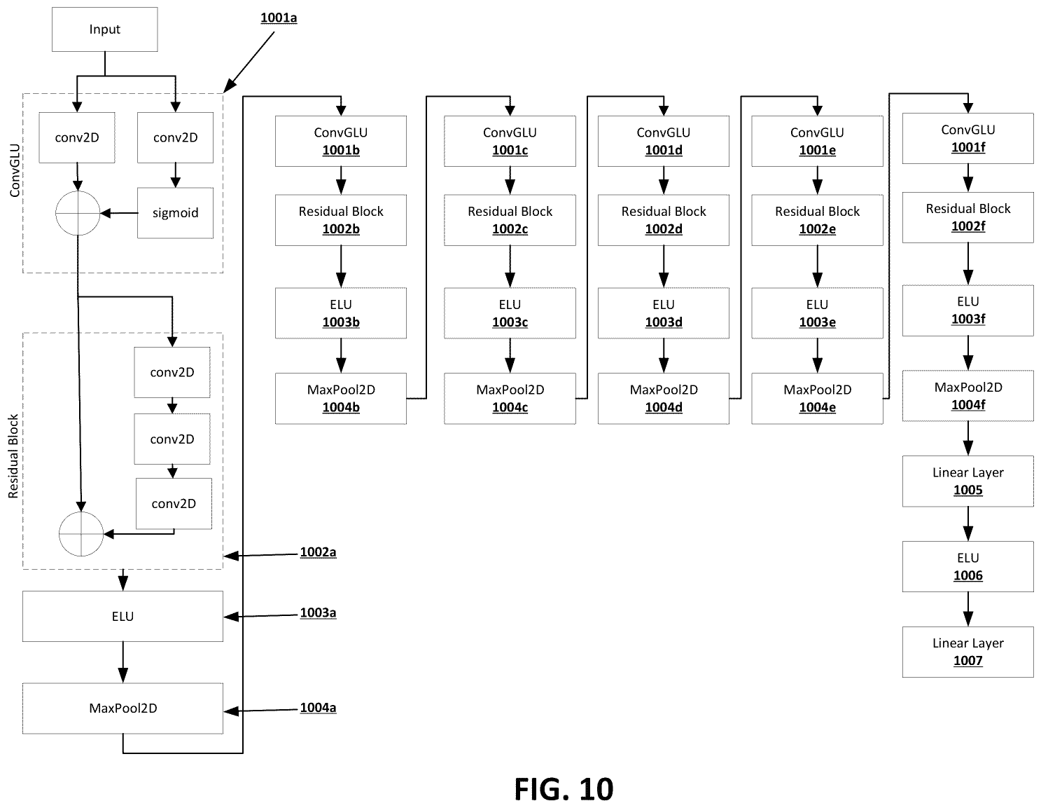

FIG. 10 illustrates an example architecture that may be used with one or more embodiments of the present disclosure. As shown in FIG. 10, an example model may include a pre-processing convolutional block 1101, a bidirectional long short-term memory (LSTM) block 1102, a linear projection layer 1103, and a post-net convolution block 1104. The pre-processing convolutional block 1101 may include a 1-dimensional convolution layer, a batch normalization layer, and an activation function (e.g., a rectified linear unit (ReLU) such as a hyperbolic tangent (tan h) activation function). The post-net convolution block 1104 may include one or more 1-dimensional convolution layers, one or more batch normalization layers, and an activation function to identify and classify each target source.

The example architectures depicted in FIGS. 9 and 10 may be used in accordance with audio source feature classification models (e.g., 204) described herein, as well as audio generation models (e.g., 207) described herein.

In some embodiments, the audio signal processing apparatus 104 can be used as part of a conferencing system that replaces the classically defined functions of beamforming, acoustic echo cancellation, noise reduction and denoising. In some embodiments, two or more sensor elements in fixed relative positions digitally sample time-domain signals propagated from signal sources in a reflective environment. In some embodiments, one or more of the above disclosed machine learning models (e.g., the audio source feature separation model, the audio source feature classification model, audio generation model, or some combined machine learning model encompassing operations of two or more of the above described models) processes real-time audio signals and separates the input mixture into multiple principal components that are analyzed to classify components into functional channels, which are selectively chosen to regenerate and recombine into an output mixture. In some embodiments, the far end audio content that would create echo, for example, is not a component that is recombined, and undesired non-speech sources such as background noise and errant non-stationary noise are not recombined.

In some embodiments, the audio signal processing apparatus 104 can be used as part of a conferencing system that replaces the classically defined functions of beamforming, acoustic echo cancellation, and noise reduction and denoising. In some embodiments, two or more sensor elements in fixed relative positions digitally sample time-domain signals propagated from signal sources in a reflective environment. In some embodiments, one or more machine learning models as discussed above may be configured to process real-time audio signals and analyze the input mixture to classify and identify principal audio components. The principal audio components are tagged into desired and undesired source classification where desired sources are typically the near-end speech sources and the undesired sources are far-end echo, background noise, and errant non-stationary noise. In some embodiments, signal decomposition parameters that describe/transform the audio signals are used to regenerate the principal audio sources. In some embodiments, only the desired audio sources are generated and combined together to create an audio output.

### Example Apparatus

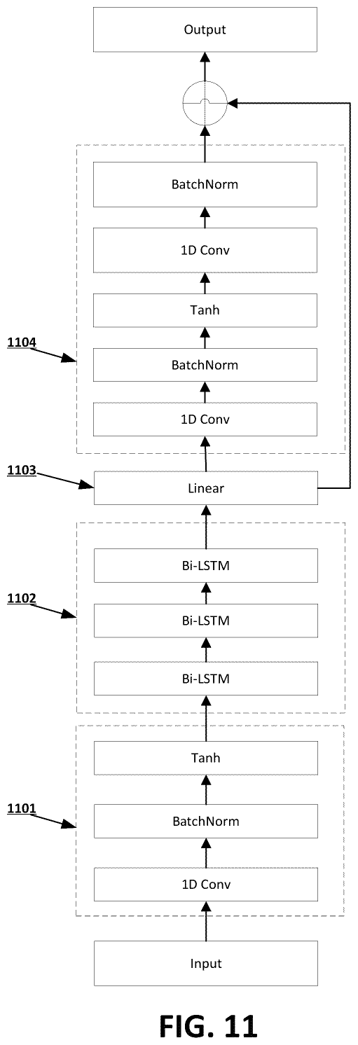

An example architecture for the audio signal processing apparatus 104 is depicted in the apparatus 900 of FIG. 11. As depicted in FIG. 11, the apparatus 900 includes processor 902, memory 904, input/output circuitry 906, and communications circuitry 908. Although these components 902-912 are described with respect to functional limitations, it should be understood that the particular implementations necessarily include the use of particular hardware. It should also be understood that certain of these components 902-912 may include similar or common hardware. For example, two sets of circuitries may both leverage use of the same processor, network interface, storage medium, or the like to perform their associated functions, such that duplicate hardware is not required for each set of circuitries.

In one embodiment, the processor 902 (and/or co-processor or any other processing circuitry assisting or otherwise associated with the processor) may be in communication with the memory 904 via a bus for passing information among components of the apparatus. The memory 904 is non-transitory and may include, for example, one or more volatile and/or non-volatile memories. In other words, for example, the memory 204 may be an electronic storage device (e.g., a computer-readable storage medium). The memory 904 may be configured to store information, data, content, applications, instructions, or the like for enabling the apparatus to carry out various functions in accordance with example embodiments of the present disclosure. For example, the memory 904 may be configured to store audio signal sample data, audio source feature separation model data, isolate source audio feature data, isolate source audio component data, audio generation machine learning model data, target source generated audio sample data, audio source classification machine learning model data, audio source category data, desired audio source data, undesired audio source data, audio sample standard data, and the like.

The processor 902 may be embodied in a number of different ways and may, for example, include one or more processing devices configured to perform independently. In some preferred and non-limiting embodiments, the processor 902 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some embodiments, the processor 902 may be a central processing unit (CPU), a microprocessor, a coprocessor, a digital signal processor (DSP), an Advanced RISC Machine (ARM), a field programmable gate array (FPGA), a controller, or a processing element. The processor 902 may also be embodied in various other processing circuitry including integrated circuits such as, for example, a microcontroller unit (MCU), an ASIC (application specific integrated circuit), a hardware accelerator (for example, a neural processor unit or NPU), or a special-purpose electronic chip. Furthermore, in some embodiments, the processor 902 may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In some preferred and non-limiting embodiments, the processor 902 may be configured to execute instructions stored in the memory 904 or otherwise accessible to the processor 902. In some preferred and non-limiting embodiments, the processor 902 may be configured to execute hard-coded functionalities. As such, whether configured by hardware or software methods, or by a combination thereof, the processor 902 may represent an entity (e.g., physically embodied in circuitry) capable of performing operations according to an embodiment of the present disclosure while configured accordingly. Alternatively, as another example, when the processor 902 is embodied as an executor of software instructions, the instructions may specifically configure the processor 902 to perform the algorithms and/or operations described herein when the instructions are executed.

In one embodiment, the apparatus 900 may include input/output circuitry 906 that may, in turn, be in communication with processor 902 to provide output to the user and, in one embodiment, to receive an indication of a user input. The input/output circuitry 906 may comprise a user interface and may include a display, and may comprise a web user interface, a mobile application, a client device, a kiosk, or the like. In one embodiment, the input/output circuitry 906 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 904, and/or the like).

The communications circuitry 908 may be any means such as a device or circuitry embodied in either hardware or a combination of hardware and software that is configured to receive and/or transmit data from/to a network and/or any other device, circuitry, or module in communication with the apparatus 900. In this regard, the communications circuitry 908 may include, for example, a network interface for enabling communications with a wired or wireless communication network.

The sensor interfaces 910 may be configured to receive audio signals from the audio sensors 102a-e. Examples of audio sensors 102a-e include microphones (including wireless microphones) and wireless audio receivers. Wireless audio receivers, wireless microphones, and other wireless audio sensors typically include antennas for transmitting and receiving radio frequency (RF) signals which contain digital or analog signals, such as modulated audio signals, data signals, and/or control signals. A wireless audio receiver may be configured to receive RF signals from one or more wireless audio transmitters over one or more channels and corresponding frequencies. For example, a wireless audio receiver may have a single receiver channel so that the receiver is able to wirelessly communicate with one wireless audio transmitter at a corresponding frequency. As another example, a wireless audio receiver may have multiple receiver channels, where each channel can wirelessly communicate with a corresponding wireless audio transmitter at a respective frequency.

The output interfaces 912 may be configured to provide generated audio samples to audio output devices 103.

In some embodiments, the communications circuitry 908 may include one or more network interface cards, antennae, buses, switches, routers, modems, and supporting hardware and/or software, or any other device suitable for enabling communications via a network. Additionally or alternatively, the communications circuitry 908 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 900. In one embodiment, one or more external systems (such as a remote cloud computing and/or data storage system) may also be leveraged to provide at least some of the functionality discussed herein.

With respect to components of the apparatus 900, the term “circuitry” as used herein and defined above should therefore be understood to include particular hardware configured to perform the functions associated with the particular circuitry as described herein. For example, in one embodiment, “circuitry” may include processing circuitry, storage media, network interfaces, input/output devices, and the like. In one embodiment, other elements of the apparatus 900 may provide or supplement the functionality of particular circuitry. For example, the processor 902 may provide processing functionality, the memory 904 may provide storage functionality, the communications circuitry 908 may provide network interface functionality, and the like. Similarly, other elements of the apparatus 900 may provide or supplement the functionality of particular circuitry.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Additional Implementation Details

Although example processing systems have been described herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a device is described herein to receive data from another device, it will be appreciated that the data may be received directly from another device or may be received indirectly via one or more intermediary devices, such as, for example, one or more servers, relays, routers, network access points, base stations, hosts, and/or the like (sometimes referred to herein as a “network”). Similarly, where a device is described herein to send data to another device, it will be appreciated that the data may be sent directly to another device or may be sent indirectly via one or more intermediary devices, such as, for example, one or more servers, relays, routers, network access points, base stations, hosts, and/or the like.

The term “circuitry” should be understood broadly to include hardware and, in some embodiments, software for configuring the hardware. With respect to components of the apparatus, the term “circuitry” as used herein should therefore be understood to include particular hardware configured to perform the functions associated with the particular circuitry as described herein. For example, in some embodiments, “circuitry” may include processing circuitry, storage media, network interfaces, input/output devices, and the like.

The term “user” should be understood to refer to an individual, group of individuals, business, organization, and the like. The users referred to herein may access a group-based communication platform using client devices (as defined herein).

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. An audio signal processing apparatus comprises one or more processors and one or more memories storing instructions that are operable, when executed by the one or more processors, to cause the audio signal processing apparatus to input an audio signal sample associated with at least one audio capture device to an audio source feature separation model that is configured to generate one or more isolate source audio features from the audio signal sample, input the one or more isolate source audio features to an audio generation model that is configured to generate a target source generated audio sample based at least in part on the one or more isolate source audio features, and output the target source generated audio sample to one or more audio output devices.

Clause 2. An audio signal processing apparatus according to the foregoing Clause, wherein each isolate source audio feature is associated with a targeted portion of the audio signal sample and the audio generation model is configured to generate the target source generated audio sample from the one or more isolate source audio features.

Clause 3. An audio signal processing apparatus according to any of the foregoing Clauses, where the one or more memories storing instructions are operable, when executed by the one or more processors, to further cause the audio signal processing apparatus to input the one or more isolate source audio features and one or more isolate source audio components to an audio source feature classification model configured to classify the one or more isolate source audio features into one or more audio source categories, and based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features or isolate source audio components.

Clause 4. An audio signal processing apparatus according to any of the foregoing Clauses, wherein the one or more audio source categories include at least a desired or targeted audio source category and undesired audio source category.

Clause 5. An audio signal processing apparatus according to any of the foregoing Clauses, wherein one or more of the isolate source audio feature or the isolate source audio component is classified into the one or more audio source categories based at least in part on at least one of an associated time domain signal, frequency domain signal, signal coordinate, signal class, or signal confidence.

Clause 6. An audio signal processing apparatus according to any of the foregoing Clauses, wherein the desired or targeted audio source category includes one or more identified individual speakers.

Clause 7. An audio signal processing apparatus according to any of the foregoing Clauses, wherein the one or more memories storing instructions are operable, when executed by the one or more processors, to further cause the audio signal processing apparatus to input the one or more isolate source audio features and one or more isolate source audio components to an audio source feature classification model configured to classify the one or more isolate source audio features and the one or more isolate source audio components into one or more audio source categories, and based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features and isolate source audio components.

Clause 8. An audio signal processing apparatus according to any of the foregoing Clauses, wherein the audio source feature separation model comprises a non-invertible transform layer configured to perform one or more feature extraction or non-invertible transform operations on the audio signal sample.

Clause 9. An audio signal processing apparatus according to any of the foregoing Clauses, wherein the audio source feature separation model is configured to perform one or more audio processing operations on the one or more target audio source components to generate a target audio source component feature set for the one or more target audio source components, and the audio generation model is configured to process the target source component feature set to generate the target source generated audio sample.

Clause 10. An audio signal processing apparatus according to any of the foregoing Clauses, wherein the audio source feature separation model is configured to perform one or more audio processing operations on the one or more target audio source components to generate one or more partial target source generated audio samples for the one or more target audio source components, and the audio generation model is configured to provide the one or more partial target source generated audio samples to a set of target selection layers that are configured to process the partial target source generated audio samples to generate the target source generated audio sample.

Clause 11. An audio signal processing apparatus according to any of the foregoing Clauses, wherein the one or more isolate source audio features is in a non-invertible domain.

Clause 12. An audio signal processing apparatus according to any of the foregoing Clauses, wherein one or more of the isolate source audio features or an isolate source audio component is classified as a far end audio signals and the audio generation model excludes the far end audio signals when generating the target source.

Clause 13. An audio signal processing apparatus according to any of the foregoing Clauses, wherein the audio generation model is further configured to perform one or more audio signal processing techniques including one or more of automatic gain control or audio filtering to generate the target source.

Clause 14. An audio signal processing apparatus according to any of the foregoing Clauses, wherein the audio source feature separation model is configured to generate the one or more isolate source audio features from the audio signal sample or to generate the one or more isolate source audio features from one or more isolate source audio components generated based on the audio signal sample.

Clause 15. A computer program product comprising at least one non-transitory computer readable storage medium having computer-readable program code portions stored thereon that, when executed by at least one processor, cause an apparatus to input an audio signal sample associated with at least one audio capture device to an audio source feature separation model that is configured to generate one or more isolate source audio features from the audio signal sample, input the one or more isolate source audio features to an audio generation model that is configured to generate a target source generated audio sample based at least in part on the one or more isolate source audio features, and output the target source generated audio sample to one or more audio output devices.

Clause 16. A computer program product according to the foregoing Clause, wherein each isolate source audio feature is associated with a targeted portion of the audio signal sample and the audio generation model is configured to generate the target source generated audio sample from the one or more isolate source audio features.

Clause 17. A computer program product according to any of the foregoing Clauses, wherein the computer-readable program code portions, when executed by the at least one processor, further cause the apparatus to input the one or more isolate source audio features and one or more isolate source audio components to an audio source feature classification model configured to classify the one or more isolate source audio features into one or more audio source categories, and based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features or isolate source audio components.

Clause 18. A computer program product according to any of the foregoing Clauses, wherein the one or more audio source categories include at least a desired or targeted audio source category and undesired audio source category.

Clause 19. A computer program product according to any of the foregoing Clauses, wherein one or more of the isolate source audio feature or the isolate source audio component is classified into the one or more audio source categories based at least in part on at least one of an associated time domain signal, frequency domain signal, signal coordinate, signal class, or signal confidence.

Clause 20. A computer program product according to any of the foregoing Clauses, wherein the desired or targeted audio source category includes one or more identified individual speakers.

Clause 21. A computer program product according to any of the foregoing Clauses, wherein the computer-readable program code portions, when executed by the at least one processor, further cause the apparatus to input the one or more isolate source audio features and one or more isolate source audio components to an audio source feature classification model configured to classify the one or more isolate source audio features and the one or more isolate source audio components into one or more audio source categories, and based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features and isolate source audio components.

Clause 22. A computer program product according to any of the foregoing Clauses, wherein the audio source feature separation model comprises a non-invertible transform layer configured to perform one or more feature extraction or non-invertible transform operations on the audio signal sample.

Clause 23. A computer program product according to any of the foregoing Clauses, wherein the audio source feature separation model is configured to perform one or more audio processing operations on the one or more target audio source components to generate a target audio source component feature set for the one or more target audio source components, and the audio generation model is configured to process the target source component feature set to generate the target source generated audio sample.

Clause 24. A computer program product according to any of the foregoing Clauses, wherein the audio source feature separation model is configured to perform one or more audio processing operations on the one or more target audio source components to generate one or more partial target source generated audio samples for the one or more target audio source components, and the audio generation model is configured to input the one or more partial target source generated audio samples to a set of target selection layers that are configured to process the partial target source generated audio samples to generate the target source generated audio sample.

Clause 25. A computer program product according to any of the foregoing Clauses, wherein the one or more isolate source audio features is in a non-invertible domain.

Clause 26. A computer program product according to any of the foregoing Clauses, wherein one or more of the isolate source audio features or an isolate source audio component is classified as a far end audio signals and the audio generation model excludes the far end audio signals when generating the target source.

Clause 27. A computer program product according to any of the foregoing Clauses, wherein the audio generation model is further configured to perform one or more audio signal processing techniques including one or more of automatic gain control or audio filtering to generate the target source.

Clause 28. A computer program product according to any of the foregoing Clauses, wherein the audio source feature separation model is configured to generate the one or more isolate source audio features from the audio signal sample or to generate the one or more isolate source audio features from one or more isolate source audio components generated based on the audio signal sample.

Clause 29. A method, comprising inputting an audio signal sample associated with at least one audio capture device to an audio source feature separation model that is configured to generate one or more isolate source audio features from the audio signal sample, inputting the one or more isolate source audio features to an audio generation model that is configured to generate a target source generated audio sample based at least in part on the one or more isolate source audio features, and outputting the target source generated audio sample to one or more audio output devices.

Clause 30. A method according to the foregoing Clause, wherein each isolate source audio feature is associated with a targeted portion of the audio signal sample and the audio generation model is configured to generate the target source generated audio sample from the one or more isolate source audio features.

Clause 31. A method according to any of the foregoing Clauses, further comprising inputting the one or more isolate source audio features and one or more isolate source audio components to an audio source feature classification model configured to classify the one or more isolate source audio features into one or more audio source categories, and based on determining that the one or more audio source categories are associated with a target source, inputting the one or more audio source categories to the audio generation model, wherein the audio generation model is configured to generate the target source generated audio sample based at least in part on one or more of the one or more audio source categories of the one or more isolate source audio features or isolate source audio components.

Clause 32. A method according to any of the foregoing Clauses, wherein the one or more audio source categories include at least a desired or targeted audio source category and undesired audio source category.

Clause 33. A method according to any of the foregoing Clauses, wherein one or more of the isolate source audio feature or the isolate source audio component is classified into the one or more audio source categories based at least in part on at least one of an associated time domain signal, frequency domain signal, signal coordinate, signal class, or signal confidence.

Clause 34. A method according to any of the foregoing Clauses, wherein the desired or targeted audio source category includes one or more identified individual speakers.

Clause 35. A method according to any of the foregoing Clauses, further comprising inputting the one or more isolate source audio features and one or more isolate source audio components to an audio source feature classification model configured to classify the one or more isolate source audio features and the one or more isolate source audio components into one or more audio source categories, and based on determining that the one or more audio source categories are associated with a target source, inputting the one or more audio source categories to the audio generation model, wherein the audio generation model is configured to generate the target source generated audio sample based at least in part on one or more of the one or more audio source categories of the one or more isolate source audio features and isolate source audio components.

Clause 36. A method according to any of the foregoing Clauses, wherein the audio source feature separation model comprises a non-invertible transform layer configured to perform one or more feature extraction or non-invertible transform operations on the audio signal sample.

Clause 37. A method according to any of the foregoing Clauses, wherein the audio source feature separation model is configured to perform one or more audio processing operations on the one or more target audio source components to generate a target audio source component feature set for the one or more target audio source components, and the audio generation model is configured to process the target source component feature set to generate the target source generated audio sample.

Clause 38. A method according to any of the foregoing Clauses, wherein the audio source feature separation model is configured to perform one or more audio processing operations on the one or more target audio source components to generate one or more partial target source generated audio samples for the one or more target audio source components, and the audio generation model is configured to input the one or more partial target source generated audio samples to a set of target selection layers that are configured to process the partial target source generated audio samples to generate the target source generated audio sample.

Clause 39. A method according to any of the foregoing Clauses, wherein the one or more isolate source audio features is in a non-invertible domain.

Clause 40. A method according to any of the foregoing Clauses, wherein one or more of the isolate source audio features or an isolate source audio component is classified as a far end audio signals and the audio generation model excludes the far end audio signals when generating the target source.

Clause 41. A method according to any of the foregoing Clauses, wherein the audio generation model is further configured to perform one or more audio signal processing techniques including one or more of automatic gain control or audio filtering to generate the target source.

Clause 42. A method according to any of the foregoing Clauses, wherein the audio source feature separation model is configured to generate the one or more isolate source audio features from the audio signal sample or to generate the one or more isolate source audio features from one or more isolate source audio components generated based on the audio signal sample.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An audio signal processing apparatus comprising one or more processors and one or more memories storing instructions that are operable, when executed by the one or more processors, to cause the audio signal processing apparatus to:
input an audio signal sample associated with at least one audio capture device to an audio source feature separation model that is configured to generate one or more isolate source audio features from the audio signal sample;
input the one or more isolate source audio features to an audio generation model that is configured to generate a target source generated audio sample based at least in part on the one or more isolate source audio features; and
output the target source generated audio sample to one or more audio output devices.

2. The audio signal processing apparatus of claim 1, wherein each isolate source audio feature is associated with a targeted portion of the audio signal sample and the audio generation model is configured to generate the target source generated audio sample from the one or more isolate source audio features.

3. The audio signal processing apparatus of claim 1, the one or more memories storing instructions that are operable, when executed by the one or more processors, to further cause the audio signal processing apparatus to:
input the one or more isolate source audio features and one or more isolate source audio components to an audio source feature classification model configured to classify the one or more isolate source audio features into one or more audio source categories; and
based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features or isolate source audio components.

4. The audio signal processing apparatus of claim 3, wherein the one or more audio source categories include at least a desired or targeted audio source category and undesired audio source category.

5. The audio signal processing apparatus of claim 3, wherein one or more of the isolate source audio feature or the isolate source audio component is classified into the one or more audio source categories based at least in part on at least one of an associated time domain signal, frequency domain signal, signal coordinate, signal class, or signal confidence.

6. The audio signal processing apparatus of claim 3, wherein the desired or targeted audio source category includes one or more identified individual speakers.

7. The audio signal processing apparatus of claim 1, the one or more memories storing instructions that are operable, when executed by the one or more processors, to further cause the audio signal processing apparatus to:
input the one or more isolate source audio features and one or more isolate source audio components to an audio source feature classification model configured to classify the one or more isolate source audio features and the one or more isolate source audio components into one or more audio source categories; and
based on determining that the one or more audio source categories are associated with a target source, input the one or more audio source categories to the audio generation model, wherein the audio generation model is configured to generate the target source generated audio sample based at least in part on one or more of the one or more audio source categories of the one or more isolate source audio features and isolate source audio components.

8. The audio signal processing apparatus of claim 1, wherein the audio source feature separation model comprises a non-invertible transform layer configured to perform one or more feature extraction or non-invertible transform operations on the audio signal sample.

9. The audio signal processing apparatus of claim 1, wherein:
the audio source feature separation model is configured to perform one or more audio processing operations on the one or more target audio source components to generate a target audio source component feature set for the one or more target audio source components, and
the audio generation model is configured to process the target source component feature set to generate the target source generated audio sample.

10. The audio signal processing apparatus of claim 1, wherein:
the audio source feature separation model is configured to perform one or more audio processing operations on the one or more target audio source components to generate one or more partial target source generated audio samples for the one or more target audio source components, and
the audio generation model is configured to provide the one or more partial target source generated audio samples to a set of target selection layers that are configured to process the partial target source generated audio samples to generate the target source generated audio sample.

11. The audio signal processing apparatus of claim 1, wherein the one or more isolate source audio features is in a non-invertible domain.

12. The audio signal processing apparatus of claim 1, wherein one or more of the isolate source audio features or an isolate source audio component is classified as a far end audio signals and the audio generation model excludes the far end audio signals when generating the target source.

13. The audio signal processing apparatus of claim 1, wherein the audio generation model is further configured to perform one or more audio signal processing techniques including one or more of automatic gain control or audio filtering to generate the target source.

14. The audio signal processing apparatus of claim 1, wherein the audio source feature separation model is configured to generate the one or more isolate source audio features from the audio signal sample or to generate the one or more isolate source audio features from one or more isolate source audio components generated based on the audio signal sample.

15. A computer program product comprising at least one non-transitory computer readable storage medium having computer-readable program code portions stored thereon that, when executed by at least one processor, cause an apparatus to:
input an audio signal sample associated with at least one audio capture device to an audio source feature separation model that is configured to generate one or more isolate source audio features from the audio signal sample;
input the one or more isolate source audio features to an audio generation model that is configured to generate a target source generated audio sample based at least in part on the one or more isolate source audio features; and
output the target source generated audio sample to one or more audio output devices.

16-28. (canceled)

29. A method, comprising:
inputting an audio signal sample associated with at least one audio capture device to an audio source feature separation model that is configured to generate one or more isolate source audio features from the audio signal sample;
inputting the one or more isolate source audio features to an audio generation model that is configured to generate a target source generated audio sample based at least in part on the one or more isolate source audio features; and
outputting the target source generated audio sample to one or more audio output devices.

30. The method of claim 29, wherein each isolate source audio feature is associated with a targeted portion of the audio signal sample and the audio generation model is configured to generate the target source generated audio sample from the one or more isolate source audio features.

31. The method of claim 29, further comprising:
inputting the one or more isolate source audio features and one or more isolate source audio components to an audio source feature classification model configured to classify the one or more isolate source audio features into one or more audio source categories; and
based on determining that the one or more audio source categories are associated with a target source, inputting the one or more audio source categories to the audio generation model, wherein the audio generation model is configured to generate the target source generated audio sample based at least in part on one or more of the one or more audio source categories of the one or more isolate source audio features or isolate source audio components.

32. The method of claim 31, wherein the one or more audio source categories include at least a desired or targeted audio source category and undesired audio source category.

33-42. (canceled)
